(19) United States
(12) Patent Application Publication
(10) Pub. No.: US 2026/0266445 A1
(43) Pub. Date: Sep. 10, 2026

(54) LAMP UNIT AND VEHICLE LAMP

(71) Applicant: ICHIKOH INDUSTRIES, LTD., Isehara-shi (JP)

(72) Inventor: Yasuhiro OKUBO, Kanagawa (JP)

(73) Assignee: ICHIKOH INDUSTRIES, LTD., Isehara-shi (JP)

(21) Appl. No.: 19/165,806

(22) PCT Filed: Mar. 27, 2024
(86) PCT No.: PCT/JP2024/012312

§ 371 Date: Sep. 16, 2025

(30) Foreign Application Priority Data
Mar. 30, 2023 (JP) 2023-056183

(51) Int. Cl. F21S 43/20

(52) U.S. Cl. CPC F21S 43/2605

(57) ABSTRACT

A lamp unit includes: one light emission unit that emits light; a condenser lens that condenses light emitted from the light emission unit; a light blocking member having a slit through which the light condensed by the condenser lens passes; and a projection lens that projects the light that has passed through the light blocking member to form an irradiation pattern. The light emission unit is arranged such that a center thereof in an up-down direction is above a projection lens optical axis. The slit is arranged to extend upward from the projection lens optical axis.

### BACKGROUND ART

A lamp unit including a shade that blocks a part of light from a light source and a projection lens that projects light through the shade to a rear side of a vehicle is known.

### PRIOR ART LITERATURE

### Patent Literature

Patent Literature 1: WO 2020/019231 A

### SUMMARY OF INVENTION

### Problems to be Solved by the Invention

In a lamp unit such as that described in Patent Literature 1, there is a need to downsize an overall configuration.

The present invention has been made in view of the above, and an object thereof is to provide a lamp unit and a vehicle lamp capable of being downsized.

### Solution to Problems

A lamp unit according to the present invention includes: one light emission unit that emits light; a condenser lens that condenses light emitted from the light emission unit; a light blocking member having a slit through which the light condensed by the condenser lens passes; and a projection lens that projects the light that has passed through the light blocking member to form an irradiation pattern. The light emission unit is arranged such that a center thereof in an up-down direction is above a projection lens optical axis. The slit is arranged to extend upward from the projection lens optical axis.

A vehicle lamp includes the lamp unit described above.

### EFFECTS OF THE INVENTION

According to the present invention, it is possible to provide a lamp unit and a vehicle lamp capable of being downsized.

### BRIEF DESCRIPTION OF DRAWINGS

FIG. 1 is an exploded perspective view illustrating an example of a lamp unit according to the present embodiment.

FIG. 2 is a view illustrating the example of the lamp unit.

FIG. 3 is a view illustrating the example of the lamp unit.

FIG. 4 is a view illustrating the example of the lamp unit.

FIG. 5 is a view illustrating a configuration along an A-A cross section in FIG. 2.

FIG. 6 is a perspective view illustrating an example of a condenser lens.

FIG. 7 is a view illustrating an example of an operation of the lamp unit according to the present embodiment.

FIG. 8 is a view illustrating the example of the operation of the lamp unit according to the present embodiment.

FIG. 9 is a view illustrating the example of the operation of the lamp unit according to the present embodiment.

FIG. 10 is a view illustrating the example of the operation of the lamp unit according to the present embodiment.

FIG. 11 is a view illustrating an example of an irradiation pattern formed on a road surface by a vehicle lamp.

### MODES FOR CARRYING OUT THE INVENTION

Hereinafter, an embodiment of a lamp unit and a vehicle lamp according to the present invention will be described with reference to the drawings. Note that the present invention is not limited by the embodiment. In addition, components in the following embodiment include what can be easily replaced by those skilled in the art or what is substantially the same.

In the following description, an front-rear direction, an up-down direction, and a right-left direction refer to directions in a vehicle mounted state in which the lamp unit and the vehicle lamp are mounted on a vehicle, and indicate directions when looking in a traveling direction of the vehicle from the driver's seat. In the present embodiment, the up-down direction is parallel to a vertical direction, and the front-rear direction and the right-left direction are parallel to a horizontal direction. A center side in the right-left direction of the vehicle is referred to as a vehicle inner side, and a side-portion side in the right-left direction of the vehicle is referred to as a vehicle outer side.

The front and rear directions are assumed to be, for example, directions in a state in which the lamp unit and the vehicle lamp are mounted on the vehicle (vehicle mounted state). For example, when mounted on a front portion (front) of the vehicle, the front is the front direction (front side), and a rear is the rear direction (rear side). When mounted on a rear portion (rear) of the vehicle, the rear is the front direction (front side), and the front is the rear direction (rear side). When mounted on a side portion (side) of the vehicle, the vehicle outer side is the front direction (front side) , and the vehicle inner side is the rear direction (rear side).

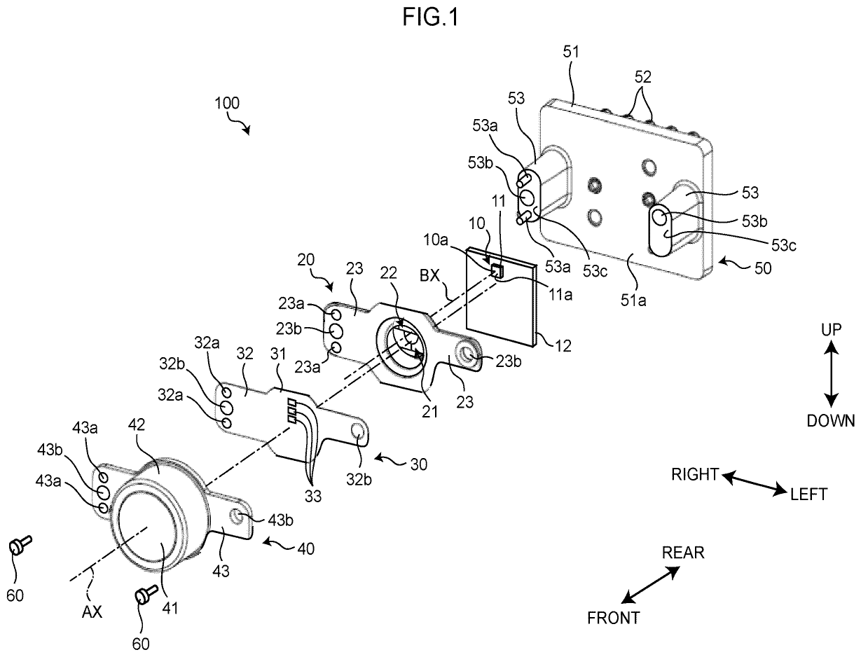

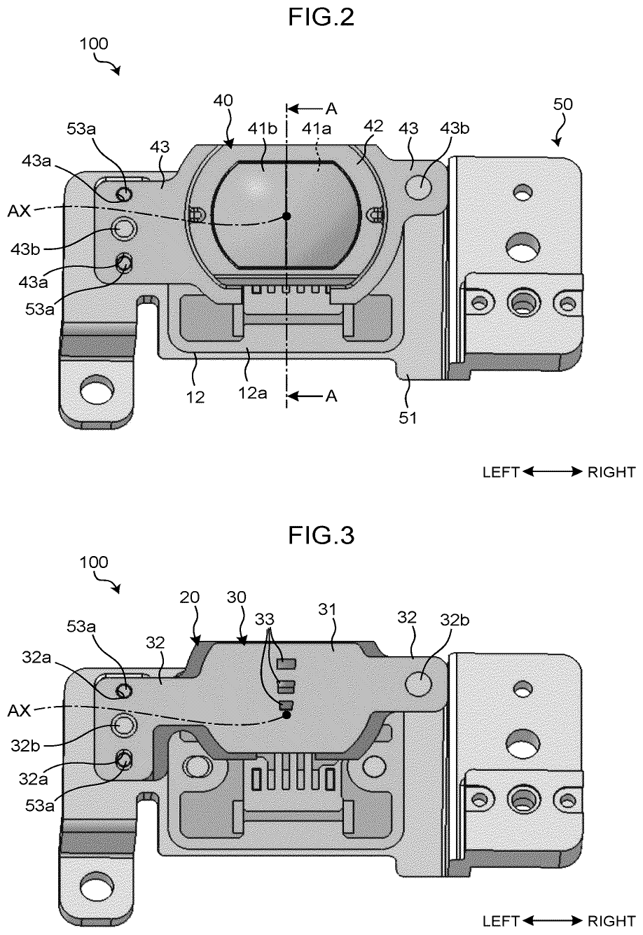

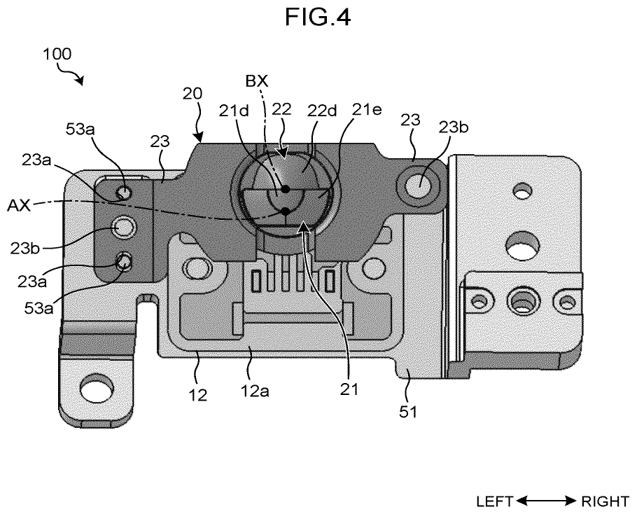

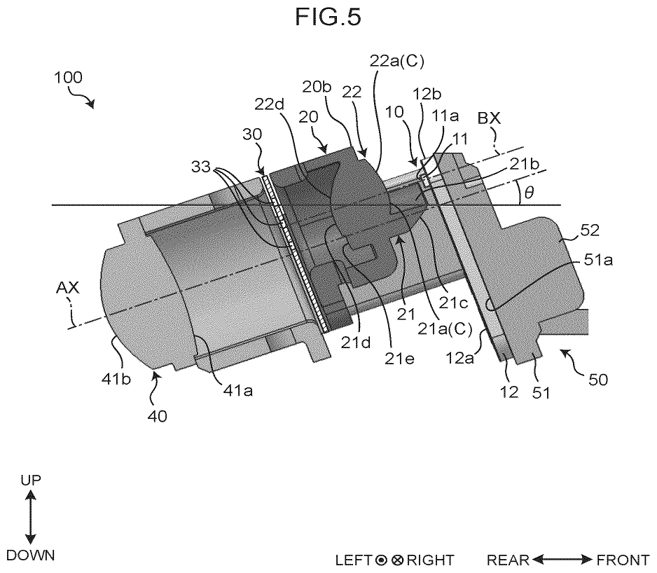

FIG. 1 is an exploded perspective view illustrating an example of a lamp unit according to the present embodiment. FIG. 2 to FIG. 4 are views illustrating the example of the lamp unit. FIG. 2 to FIG. 4 illustrate a projection lens 40 as viewed from the front side along a projection lens optical axis AX that is an optical axis of the projection lens 40. Note that FIG. 3 illustrates a state in which the projection lens 40 is omitted from the state illustrated in FIG. 2. FIG. 4 illustrates a state in which a light blocking member 30 is omitted from the state illustrated in FIG. 3. FIG. 5 is a view illustrating a configuration along an A-A cross section in FIG. 2. As illustrated in FIG. 1 to FIG. 5, the lamp unit 100 includes a light emission unit 10, a condenser lens 20, the light blocking member 30, the projection lens 40, and a support member 50.

The light emission unit 10 emits light to form an irradiation pattern P. In the present embodiment, one light emission unit 10 is provided. The light emission unit 10 has one light source 11 or a plurality of light sources 11 arranged close to each other in the right-left direction. In the present embodiment, the light emission unit 10 has, for example, one light source 11. The light source 11 is, for example, a semiconductor light source such as an LED. The light source 11 has a light emitting surface 11a that emits light. The light emitting surface 11a faces to the front. The light emission unit 10 is provided at one location in the up-down direction. That is, the light emission unit 10 is not provided in a plurality of stages in the up-down direction. In the present embodiment, a center 10a of the light emission unit 10 in the up-down direction is arranged above the projection lens optical axis AX that is the optical axis of the projection lens 40 described later. The light emission unit 10 is arranged so as to intersect a condenser lens optical axis BX described later.

The light emission unit 10 may have a configuration in which a plurality of the light sources 11 is arranged close to each other in the right-left direction, for example. In this case, one light emission unit 10 is configured by a plurality of light sources 11.

The light source 11 is mounted on a mounting surface 12a of a substrate 12. The substrate 12 has, for example, a rectangular plate shape. On the substrate 12, and a wiring line to supply power to the light source 11, a circuit, and the like are formed. The substrate 12 is arranged orthogonal or substantially orthogonal to the projection lens optical axis AX. The light source 11 is arranged on an upper part of the substrate 12. By arranging the light source 11 on the upper part of the substrate 12, it is possible to prevent the substrate 12 from projecting upward of the light source 11. The substrate 12 is supported by the support member 50.

The condenser lens 20 condenses light emitted from the light emission unit 10 and emits the light to the front side. The condenser lens 20 is made of a material capable of transmitting light emitted from the light source 11. Such a material may be, for example, a resin material such as polycarbonate; however, other materials may also be used. The condenser lens 20 includes a first lens portion 21, a second lens portion 22, and leg portions 23. The condenser lens 20 has a condenser lens optical axis BX common to the first lens portion 21 and the second lens portion 22. The condenser lens optical axis BX is arranged above the projection lens optical axis AX.

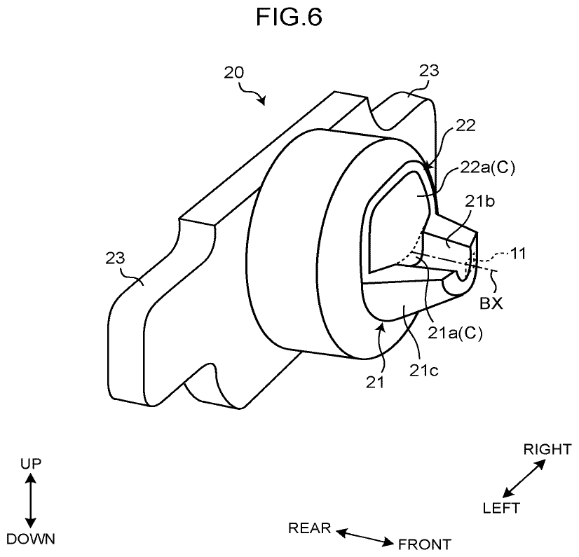

FIG. 6 is a perspective view illustrating an example of the condenser lens 20. FIG. 6 illustrates a configuration on an incident surface side of the condenser lens 20. The first lens portion 21 is arranged below the condenser lens optical axis BX. The first lens portion 21 includes a first facing incident surface 21a, an inclined incident surface 21b, a reflection surface 21c, an inner exit surface 21d, and an outer exit surface 21e.

The first facing incident surface 21a faces the light emission unit 10. More specifically, the first facing incident surface 21a faces the light emitting surface 11a of the light source 11. The first facing incident surface 21a has a semicircular shape formed on a lower side with the condenser lens optical axis BX as a center when viewed in an axial direction of the condenser lens optical axis BX. The first facing incident surface 21a forms a part of a curved surface C that protrudes toward the light emission unit 10 side. The curved surface C is, for example, a free-form surface. The light emitted from the light emission unit 10 toward the front side is incident on the first facing incident surface 21a.

The inclined incident surface 21b is arranged from a lower side of the first facing incident surface 21a to both the right and left sides, so as to surround the first facing incident surface 21a in an axial direction of the condenser lens optical axis BX. The light emitted from the light emission unit 10 in oblique directions on the lower side and on both the right and left sides is incident on the inclined incident surface 21b.

The reflection surface 21c is arranged from the lower side the inclined incident surface 21b to both the right and left sides, so as to surround the inclined incident surface 21b in the axial direction around the condenser lens optical axis BX. The reflection surface 21c internally reflects the light incident on the inclined incident surface 21b toward the front side.

The inner exit surface 21d outputs the light that has entered through the first facing incident surface 21a. The inner exit surface 21d has a semicircular shape formed below the condenser lens optical axis BX with the condenser lens optical axis BX as the center when viewed in the axial direction of the condenser lens optical axis BX.

The outer exit surface 21e outputs the light that has entered through the inclined incident surface 21b and has been reflected toward the front side by the reflection surface 21c. The outer exit surface 21e is arranged so as to surround both right and left outer sides from the lower side of the inner exit surface 21d when viewed in the axial direction of the condenser lens optical axis BX.

The second lens portion 22 is arranged above the condenser lens optical axis BX. The second lens portion 22 has a second facing incident surface 22a and an exit surface 22d.

The second facing incident surface 22a faces the light emission unit 10. More specifically, the second facing incident surface 22a faces the light emitting surface 11a of the light source 11. The second facing incident surface 22a has a semicircular shape formed on an upper side with the condenser lens optical axis BX as the center when viewed in the axial direction of the condenser lens optical axis BX.

The second facing incident surface 22a is smoothly connected to the first facing incident surface 21a. The second facing incident surface 22a constitutes a part of the curved surface C described above. That is, the first facing incident surface 21a and the second facing incident surface 22a are arranged on the one curved surface C and are smoothly connected. In other words, a portion of the curved surface C that is positioned below the condenser lens optical axis BX is the first facing incident surface 21a, and a portion that is positioned above the condenser lens optical axis BX is the second facing incident surface 22a. With this configuration, light emitted from the one light emission unit 10 toward the front side along the condenser lens optical axis BX can be made to enter along the one smooth curved surface C.

The second facing incident surface 22a protrudes in the right-left direction with respect to the first facing incident surface 21a of the first lens portion 21. That is, the second facing incident surface 22a has a larger dimension in the right-left direction than the first facing incident surface 21a. The reflection surface 21c of the first lens portion 21 protrudes in the right-left direction with respect to the second facing incident surface 22a. That is, when viewed in the axial direction of the condenser lens optical axis BX, the first lens portion 21 including the first facing incident surface 21a, the inclined incident surface 21b, and the reflection surface 21c has a larger dimension in the right-left direction than the second lens portion 22 including the second facing incident surface 22a.

The leg portions 23 protrude from the first lens portion 21 and the second lens portion 22 to the right and left sides. The leg portions 23 have opening portions 23a and 23b. Protrusion portions 53a of the support member 50 described later are inserted into the opening portions 23a. Screw members 60 described later are inserted into the opening portions 23b.

The light blocking member 30 includes a slit forming portion 31 and a protruding portion 32. The light blocking member 30 is formed in a flat plate shape with the slit forming portion 31 and the protruding portion 32 as one member. The light blocking member 30 is entirely made of a material capable of blocking light. Such materials include, for example, materials s; however, other materials may also be used. The light blocking member 30 may have a configuration in which the slit forming portion 31 and the protruding portion 32 are formed as separate members.

The slit forming portion 31 has slits 33. The slits 33 allow parts of the light condensed by the condenser lens 20 to pass therethrough. The slits 33 are formed, for example, in a state where three slits are lined up in the up-down direction. The number and arrangement of the slits 33 are not limited to those described above. Each of the slits 33 is arranged to extend upward from the projection lens optical axis AX. The slit 33 may have a portion extending in the up-down direction above the projection lens optical axis AX. In this case, for example, the entire slit 33 may be arranged above the projection lens optical axis AX, or a part of the slit 33 may be arranged across the projection lens optical axis AX in the up-down direction.

The protruding portion 32 protrudes linearly in the right-left direction from the slit forming portion 31. The protruding portion 32 has rounded corners on both sides in the right-left direction. The protruding portion 32 has flat surfaces on both the front and rear sides. The protruding portion 32 has opening portions 32a and 32b. The protrusion portions 53a of the support member 50 described later are inserted into the opening portions 32a. The screw members 60 described later is inserted into the opening portions 32b.

The light blocking member 30 is formed so as to cover the condenser lens 20 when viewed from the front side. With this configuration, the light that has passed through the condenser lens 20 can be blocked by the light blocking member 30.

The projection lens 40 includes a lens portion 41, a tubular portion 42, and a protruding portion 43. The lens portion 41 projects the lights that have passed through the slits 33 onto a road surface behind the vehicle (on the front side of the lamp unit) to form an irradiation pattern. In the projection lens 40, the lens portion 41, the tubular portion 42, and the protruding portion 43 are formed as one member. The projection lens 40 may be configured such that at least one of the lens portion 41, the tubular portion 42, or the protruding portion 43 is formed as a separate member.

The lens portion 41 is formed using a material capable of transmitting the light from the light source 11. Such a material may be, for example, a resin material such as acrylic; however, other materials may also be used. In this case, the entire projection lens 40 can be easily formed by integral molding using the material that forms the lens portion 41. In addition, in the projection lens 40, a portion different from the lens portion 41, that is, at least a part of the tubular portion 42 and the protruding portion 43 may be formed using a material different from that of the lens portion 41.

The lens portion 41 has an incident surface 41a and an exit surface 41b. The lights that have passed through the slits 33 are incident on the incident surface 41a. The exit surface 41b outputs the light incident on the incident surface 41a toward the front side.

The tubular portion 42 holds the lens portion 41. The tubular portion 42 has, for example, a cylindrical shape. The tubular portion 42 connects the lens portion 41 and the protruding portion 43. The tubular portion 42 is provided so as to protrude toward the front side with respect to the protruding portion 43. With this configuration, the lens portion 41 is disposed on the front side with respect to the protruding portion 43.

The protruding portion 43 holds the lens portion 41 via the tubular portion 42. The protruding portion 43 has a flat plate shape. The protruding portion 43 has opening portions 43a and 43b. The opening portions 43a and 43b are used for positioning with respect to fixing portions 53 of the support member 50 described later.

The support member 50 supports the light emission unit 10, the condenser lens 20, the light blocking member 30, and the projection lens 40. The support member 50 includes a base portion 51, fins 52, and fixing portions 53. The base portion 51 has a flat plate shape. The base portion 51 has a support surface 51a that supports the light emission unit 10. The support surface 51a is a front surface of the base portion 51 and supports the substrate 12.

The fins 52 protrude rearward from the base portion 51. The plurality of fins 52 is provided. The fins 52 dissipate heat generated in the light source 11.

The fixing portions 53 protrude from the support surface 51a of the base portion 51 toward the front side. The fixing portions 53 fix the protruding portion 32 and the protruding portion 43. The fixing portions 53 have protrusion portions 53a and opening portions 53b.

The protrusion portions 53a protrude to the front side and penetrate the opening portions 32a of the protruding portion 32 and the opening portions 43a of the protruding portion 43 in the front-rear direction.

The screw members 60 are inserted into the opening portions 53b. The screw members 60 fix the protruding portion 32 and the protruding portion 43 to the fixing portion 53. The screw members 60 penetrate the opening portions 32b of the protruding portion 32 and the opening portions 43b of the protruding portion 43, and are inserted into the opening portions 53b of the fixing portion 53.

As illustrated in FIG. 5, the support member 50 supports each portion such that the projection lens optical axis AX is inclined downward on the front side with respect to a horizontal plane. With this configuration, the irradiation pattern P can be efficiently formed obliquely downward on the front side of the lamp unit 100.

The substrate 12 described above is arranged such that an upper end portion 12b is located below an upper end 20b of the condenser lens 20 when the support member 50 is arranged at a projection position P2. When the support member 50 moves between a standby position Pl and the projection position P2, it is necessary to ensure a space above the lamp unit 100 in order to avoid interference with other portions. With the above arrangement of the substrate 12, a space required above the lamp unit 100 can be reduced.

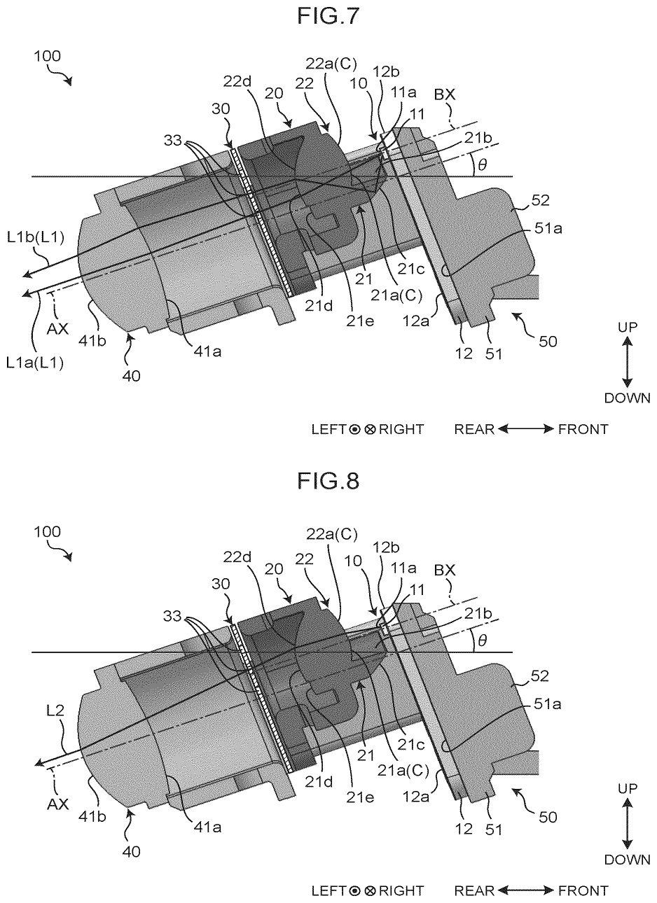

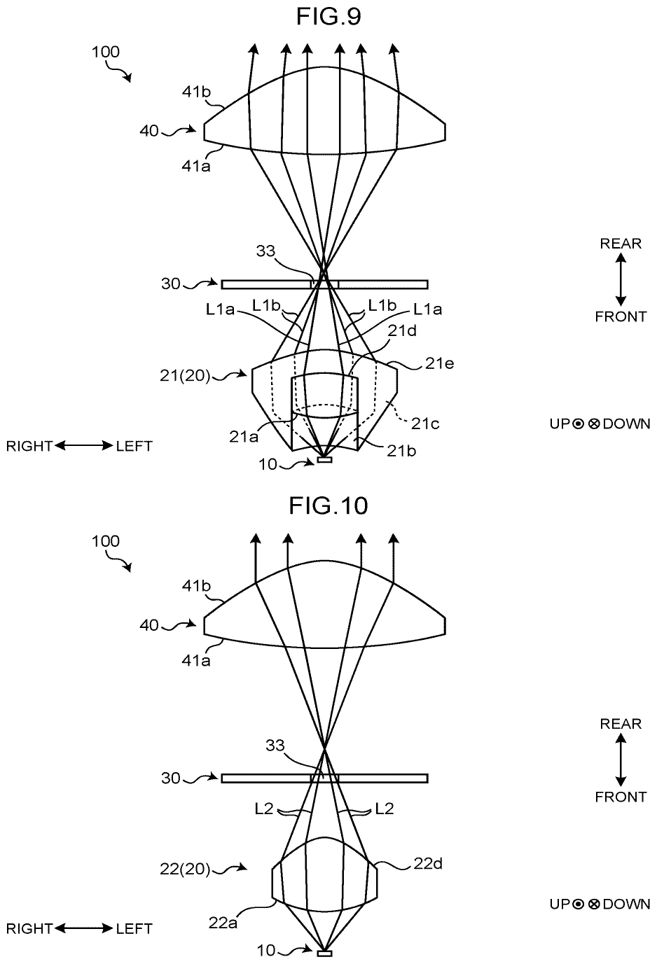

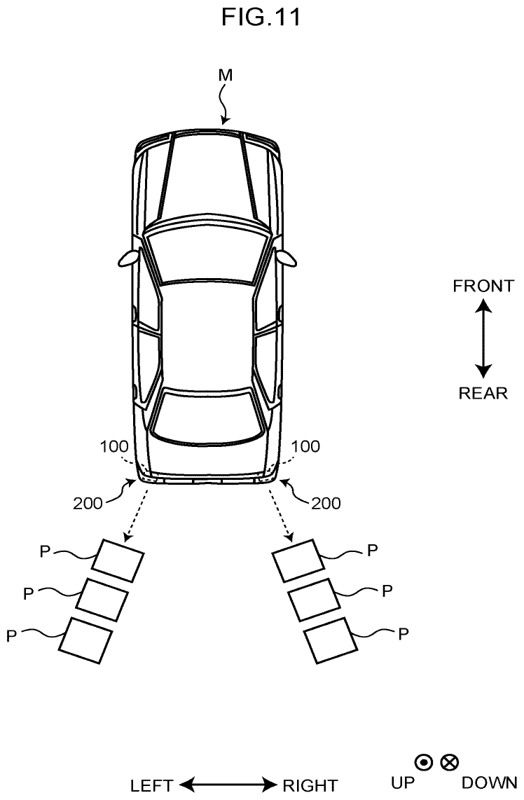

FIG. 7 to FIG. 10 are views illustrating an example of an operation of the lamp unit 100 according to the present embodiment. FIG. 7 and FIG. 8 illustrate a state as viewed from the side (cross section). FIG. 9 and FIG. 10 illustrate a state as viewed from above. The lamp unit 100 emits light from the light emitting surface 11a of the light source 11 in response to the driver's operation of a reverse gear or the like or in conjunction with lighting of a back lamp (reversing lamp) or the like.

As illustrated in FIG. 7 and FIG. 9, a part L1a of light L1 emitted downward from the light emitting surface 11a is incident on the first facing incident surface 21a of the first lens portion 21 of the condenser lens 20. Light L1a incident on the first facing incident surface 21a travels through the first lens portion 21 and is output from the inner exit surface 21d to the front side.

A part L1b of the light L1 output downward from the light emitting surface 11a is incident on the inclined incident surface 21b. Light L1b incident on the inclined incident surface 21b is reflected by the reflection surface 21c and then output from the outer exit surface 21e to the front side.

As illustrated in FIG. 8 and FIG. 10, light L2 emitted upward from the light emitting surface 11a is incident on the second facing incident surface 22a of the second lens portion 22 of the condenser lens 20 and is output from the exit surface 22d toward the front.

The light L1a output from the inner exit surface 21d, the light L1b output from the outer exit surface 21e and the light L2 output from the exit surface 22d reach the slit forming portion 31 of the light blocking member 30. The lights L1 and L2 that reach the slit forming portion 31 passe through the slits 33 of the light blocking member 30, and the rest is blocked by the light blocking member 30. The lights L1 and L2 that have passed through the slits 33 are incident on the incident surface 41a of the lens portion 41 and are output from the exit surface 41b to the front side.

As illustrated in FIG. 9 and FIG. 10, the condenser lens 20 outputs the lights L1 and L2 such that the lights L1 and L2 are each converged after passing through the slits 33. In this case, the light L that has passed through the slits 33 does not reach an outer periphery of the incident surface 41a of the projection lens 40. Thus, the irradiation pattern can be formed without using a portion of the projection lens 40 that is significantly affected by aberration. Thus, a clear irradiation pattern can be formed. As illustrated in FIG. 9, the light L1a incident on the first facing incident surface 21a and then output from the inner exit surface 21d is condensed on the front side more than the light L1b incident on the inclined incident surface 21b and then output from the outer exit surface 21e. The light L2 incident on the second facing incident surface 22a and then output from the exit surface 22d is condensed on the front side more than the lights (L1a and L2a). The more the light having passed through the slit(s) 33 is condensed on the front side, the less the light is affected by the aberration.

FIG. 11 is a view illustrating an example of the irradiation pattern formed on the road surface by the vehicle lamp 200. As illustrated in FIG. 11, the lights L1 and L2 emitted from the lamp unit 100 provided in the vehicle lamp 200 at the rear of the vehicle M toward the front side, i.e., toward the rear of the vehicle, forms irradiation patterns P on the road surface behind the vehicle.

In the condenser lens 20 of the present embodiment, the first lens 21 forms the irradiation patterns P at positions away from the vehicle using the light L1 passing through a lower slit(s) 33. In order to emit the irradiation pattern P at distant positions so as to be seen by road users outside the vehicle, it is necessary to form the irradiation patterns P with high luminous intensity. In the present embodiment, a total reflection lens including the inclined incident surface 21b, the reflection surface 21c, and the outer exit surface 21e and a refraction lens including the first facing incident surface 21a and the inner exit surface 21d are combined to concentrate the light L1 (L1a and L1b), thereby forming the irradiation patterns P with high luminous intensity.

The second lens portion 22 forms the irradiation patterns P in the vicinity of the vehicle using the light L2 that passes through an upper side of the slits 33. In this case, a refractive lens constituted by the second facing incident surface 22a and the exit surface 22d can improve the uniformity of brightness of the irradiation patterns P formed at positions close to the vehicle.

As described above, the lamp unit 100 according to the present embodiment includes the one light emission unit 10 that emits light, the condenser lens 20 that condenses the light emitted from the light emission unit 10, the light blocking member 30 having the slits 33 through which the light condensed by the condenser lens 20 passes, and the projection lens 40 that projects the light that has passed through the light blocking member 30 to form the irradiation patterns P. The light emission unit 10 is arranged such that the center 10a thereof in the up-down direction is above the projection lens optical axis AX, and the slits 33 are arranged to extend upward from the projection lens optical axis AX.

According to this configuration, the center 10a of the light emission unit 10 in the up-down direction and the slits 33 are arranged to extend upward from the projection lens optical axis AX, so that the light passing through the slit(s) 33 can be incident on the projection lens 40 near the upper side of the projection lens optical axis AX. Thus, downward light can be efficiently emitted from the projection lens 40. As a result, a downward inclination of the projection lens optical axis AX of when projecting the irradiation patterns P can be suppressed, and the space required above and below the lamp unit 100 can be reduced, whereby the vehicle lamp 200 can be downsized. Furthermore, in the present embodiment, since light is emitted from one light emission unit 10, the dimension in the up-down direction can be reduced.

In the lamp unit 100 according to the present embodiment, the condenser lens 20 is arranged such that the condenser lens optical axis BX is located above the projection lens optical axis AX. According to this configuration, the condenser lens optical axis BX is located above the projection lens optical axis AX, whereby the light condensed by the condenser lens 20 can efficiently reach the upper side of the projection lens 40.

In the lamp unit 100 according to the present embodiment, the light emission unit 10 is arranged so as to intersect the condenser lens optical axis BX. According to this configuration, the light emitted from the light emission unit 10 can reach the condenser lens 20 in a balanced manner in the up-down direction.

In the lamp unit 100 according to the present embodiment, the condenser lens 20 includes the first lens portion 21 below the condenser lens optical axis BX and the second lens portion 22 above the condenser lens optical axis BX. The first lens portion 21 includes the first facing incident surface 21a facing the light emission unit 10, the inclined incident surface 21b surrounding the first facing incident surface 21a, and the reflection surface 21c surrounding the inclined incident surface 21b. The second lens portion 22 includes the second facing incident surface 22a facing the light emission unit 10. According to this configuration, the first lens portion 21 and the second lens portion 22 can emit light with different luminous flux distributions, whereby appropriate irradiation patterns P can be formed using the light with various luminous flux distributions. That is, the light L1 passing through the lower slit(s) 33 via the first lens 21 forms the irradiation patterns P at positions away from the vehicle. In order to emit the irradiation patterns P at distant positions to be seen by road users outside the vehicle, it is necessary to form the irradiation patterns P with high luminous intensity. In the present embodiment, a total reflection lens including the inclined incident surface 21b, the reflection surface 21c, and the outer exit surface 21e and a refraction lens including the first facing incident surface 21a and the inner exit surface 21d are combined to concentrate the light L1 (L1a and L1b), thereby forming the irradiation patterns P with high luminous intensity. Furthermore, the light L2 passing through an upper side of the slits 33 via the second lens portion 22 forms the irradiation patterns P in the vicinity of the vehicle. In this case, a refractive lens constituted by the second facing incident surface 22a and the exit surface 22d can improve the uniformity of brightness of the irradiation patterns P formed at positions close to the vehicle. By using the condenser lens 20 formed by combining two different types of lenses as one, it is possible to form appropriate light distribution patterns P in a configuration in which there is the one light emission unit 10.

In the lamp unit 100 according to the present embodiment, in the condenser lens 20, the first facing incident surface 21a and the second facing incident surface 22a are arranged on the one curved surface C and are smoothly connected. With this configuration, the light emitted from the one light emission unit 10 toward the front side along the condenser lens optical axis BX can be incident along the one smooth curved surface C.

In the lamp unit 100 according to the present embodiment, the first lens portion 21 has a larger dimension in the right-left direction than the second lens portion 22. According to this configuration, the light spreading downward, rightward and leftward from the light emission unit 10 can be appropriately condensed by the first lens portion 21, and the light traveling along the axial direction of the condenser lens optical axis BX from the light emission unit 10 and the light spreading upward can be appropriately condensed by the second lens portion 22.

The lamp unit 100 according to the present embodiment further includes the support member 40 that supports the light emission unit 10, the condenser lens 20, the light blocking member 30, and the projection lens 40 such that the projection lens optical axis AX is inclined downward toward the front side. According to this configuration, the irradiation patterns P are projected with the projection lens optical axis AX inclined downward toward the front side, whereby the irradiation patterns P can be reliably formed on the road surface.

In the lamp unit 100 according to the present embodiment, the light emission unit 10 includes the light source 11 mounted on the substrate 12, and the substrate 12 is arranged such that the upper end portion 12b thereof is located below the upper end 20b of the condenser lens 20 in a front view. According to this configuration, the space required above the lamp unit 100 can be reduced.

The technical scope of the present invention is not limited to the above-described embodiment, and can be appropriately modified without departing from the spirit of the present invention. For example, although the description has been made with the configuration in which the lamp unit 100 and the vehicle lamp 200 are arranged in the rear of the vehicle M being an example in the above embodiment, the present invention is not limited to this.

The lamp unit 100 and the vehicle lamp 200 may be configured to be arranged at the front or side of the vehicle M, and may be configured to form an irradiation pattern on the road surface in front of or on the side of the vehicle M.

### EXPLANATION OF REFERENCE NUMBERS

C CURVED SURFACE
L1 (L1a and L1b) and L2 LIGHT
M VEHICLE
P IRRADIATION PATTERN
P1 STANDBY POSITION
P2 PROJECTION POSITION
AX PROJECTION LENS OPTICAL AXIS
BX CONDENSER LENS OPTICAL AXIS
10 LIGHT EMISSION UNIT
10a CENTER
11 LIGHT SOURCE
11a LIGHT EMITTING SURFACE
12 SUBSTRATE
12a MOUNTING SURFACE
12b UPPER END PORTION
20 CONDENSER LENS
20b UPPER END
21 FIRST LENS PORTION
21a FIRST FACING INCIDENT SURFACE
21b INCLINED INCIDENT SURFACE
21c REFLECTION SURFACE
21d INNER EXIT SURFACE
21e OUTER EXIT SURFACE
22 SECOND LENS PORTION
22a SECOND FACING INCIDENT SURFACE
22d, 41b EXIT SURFACE
23 LEG PORTION
23a, 23b, 32a, 32b, 43a, 43b, 53b OPENING PORTION
30 LIGHT BLOCKING MEMBER
31 SLIT FORMING PORTION
32, 43 PROTRUDING PORTION
33 SLIT
40 PROJECTION LENS
41 LENS PORTION
41a INCIDENT SURFACE
42 TUBULAR PORTION
50 SUPPORT MEMBER
51 BASE PORTION
51a SUPPORT SURFACE
52 FIN
53 FIXING PORTION
53a PROTRUSION PORTION
60 SCREW MEMBER
100 LAMP UNIT
200 VEHICLE LAMP

1. A lamp unit comprising:
one light emission unit that emits light;
a condenser lens that condenses light emitted from the light emission unit;
a light blocking member having a slit through which the light condensed by the condenser lens passes; and
a projection lens that projects the light that has passed through the light blocking member to form an irradiation pattern, wherein
the light emission unit is arranged such that a center thereof in an up-down direction is above a projection lens optical axis, and
the slit is arranged to extend upward from the projection lens optical axis.

2. The lamp unit according to claim 1, wherein
the condenser lens is arranged such that a condenser lens optical axis is located above the projection lens optical axis.

3. The lamp unit according to claim 1, wherein
the light emission unit is arranged so as to intersect a condenser lens optical axis.

4. The lamp unit according to claim 3, wherein
the condenser lens includes a first lens portion below the condenser lens optical axis and a second lens portion above the condenser lens optical axis,
the first lens portion includes a first facing incident surface facing the light emission unit, an inclined incident surface surrounding the first facing incident surface, and a reflection surface surrounding the inclined incident surface, and
the second lens portion has a second facing incident surface facing the light emission unit.

5. The lamp unit according to claim 4, wherein
in the condenser lens, the first facing incident surface and the second facing incident surface are arranged on one curved surface and are smoothly connected.

6. The lamp unit according to claim 4, wherein
the first lens portion has a larger dimension in a right-left direction than the second lens portion.

7. The lamp unit according to claim 1, further comprising
a support portion that supports the light emission unit, the condenser lens, the light blocking member, and the projection lens such that the projection lens optical axis is inclined downward toward a front side.

8. The lamp unit according to claim 7, wherein
the light emission unit includes a light source mounted on a substrate, and
the substrate is arranged such that an upper end portion thereof is located below an upper end of the condenser lens in a front view.

9. A vehicle lamp comprising: the lamp unit according to claim 1.

10. A vehicle lamp comprising: the lamp unit according to claim 2.

11. A vehicle lamp comprising: the lamp unit according to claim 3.

12. A vehicle lamp comprising: the lamp unit according to claim 4.

13. A vehicle lamp comprising: the lamp unit according to claim 5.

14. A vehicle lamp comprising: the lamp unit according to claim 6.

15. A vehicle lamp comprising: the lamp unit according to claim 7.

16. A vehicle lamp comprising: the lamp unit according to claim 8.
